(19) United States
(12) Patent Application Publication
(10) Pub. No.: US 2013/0173796 A1
(43) Pub. Date: Jul. 4, 2013

(54) SYSTEMS AND METHODS FOR MANAGING A MEDIA CONTENT QUEUE

(71) Applicants: Eric W. Grab, San Diego, CA (US); Robert Thompson, Broomall, PA (US)

(72) Inventors: Eric W. Grab, San Diego, CA (US); Robert Thompson, Broomall, PA (US)

(73) Assignee: United Video Properties, Inc., Santa Clara, CA (US)

(21) Appl. No.: 13/341,327

(22) Filed: Dec. 30, 2011

(51) Int. Cl. G06F 15/173

(52) U.S. Cl. 709/225

(57) ABSTRACT

Systems and methods for managing media content in accordance with various embodiments of the present invention are provided. A future time is identified during which a mobile device access to a network will be limited. Media content is automatically selected for transmission to the mobile device based on an environment of the mobile device at the future time. The selected content is transmitted to the mobile device for storage in a memory of the mobile device. In some embodiments, media content may be automatically selected from a media content queue for transmission to the mobile device. The selected content may be transmitted without receiving a request from the mobile device.

### BACKGROUND OF THE INVENTION

Users of modern entertainment systems receive media content from many different sources. Navigating through so many sources can be time consuming and frustrating for users, resulting in diminished interaction with media content. Each source or service tries to be the single source of media content. In addition, because video is a relatively large digital asset, users may not be able to access all media content all the time, even with advances in storage and network speeds.

### SUMMARY OF THE INVENTION

In view of the foregoing, systems and methods for managing media content in accordance with various embodiments of the present invention are provided. In particular, a future time is identified during which a mobile device access to a network will be limited. Media content is automatically selected for transmission to the mobile device based on an environment of the mobile device at the future time. In some embodiments, media content may be automatically selected for transmission to the mobile device based on mobile device configuration information. Mobile device configuration information may include at least one of size of memory of the mobile device, processor type of the mobile device, and communications circuitry of the mobile device. The selected content is transmitted to the mobile device for storage in a memory of the mobile device. In some embodiments, the selected content is transmitted without receiving a request from the mobile device.

In some embodiments, media content may be automatically selected from a media content queue for transmission to the mobile device. The selected content may be downloaded onto the mobile device at an appropriate time. In some embodiments, a user may view which content from the queue has been selected for downloading. The order of media content in the queue may be rearranged based on which media content is selected for downloading to the mobile device.

In some embodiments, a possible location may be determined where a user of the mobile device will be at the identified future time. The priority of each of the selected content may be determined relative to others of the selected content based on the determined possible location.

In some embodiments, the priority of each of the selected content may be determined based on at least one of how long the mobile device will have access to the network before the identified future time, network speed, memory available on the mobile device, and playback capabilities of the mobile device.

In some embodiments, identifying the future time during which the mobile device access to the network will be limited may include accessing a calendar associated with the user. The determined possible location may be a location indicated by a scheduled event on the calendar. In some embodiments, the determined possible location may be a home of a friend of the user. In some embodiments, the priority of each of the selected content may be determined based on what type of media content the user will likely want to access while at the home of the friend.

In some embodiments, the environment of the mobile device at the future time may include at least one of an airport, a venue, a geographical location, another user associated with a user of the mobile device, a length of time the mobile device will be at a geographical location, and a length of time the mobile device will lack access to the network.

In some embodiments, the selected content for transmission to the mobile device may be selected based on a measure of time representing when the mobile device will lose access to the network. In some embodiments, an optimal time may be determined to automatically transmit the selected content to the mobile device.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance data in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5A shows an illustrative user equipment device with a network connection in accordance with an embodiment of the invention;

FIG. 5B shows an illustrative user equipment device that lacks access to a network in accordance with an embodiment of the invention;

FIG. 6A shows an illustrative display screen of a media content queue in accordance with an embodiment of the invention;

FIG. 6B shows an illustrative display screen of a media content queue in accordance with another embodiment of the invention;

FIG. 7 shows an illustrative display screen of a calendar in accordance with an embodiment of the invention;

FIG. 8 shows an illustrative network availability data structure that may be used to determine whether a network is available at a location in accordance with an embodiment of the invention;

FIG. 9A shows an illustrative display screen of media content stored in a local memory in accordance with an embodiment of the invention;

FIG. 9B shows an illustrative display screen of media content stored in a local memory in accordance with another embodiment of the invention;

FIG. 9C shows an illustrative display screen of media content stored in a local memory in accordance with a third embodiment of the invention;

FIG. 10 is an illustrative flow diagram for managing media content in accordance with an embodiment of the invention;

FIG. 11 is an illustrative flow diagram for prioritizing media content in accordance with an embodiment of the invention; and

FIG. 12 is an illustrative flow diagram for selecting media content for transmission to a mobile device in accordance with an embodiment of the invention.

### DETAILED DESCRIPTION OF THE INVENTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

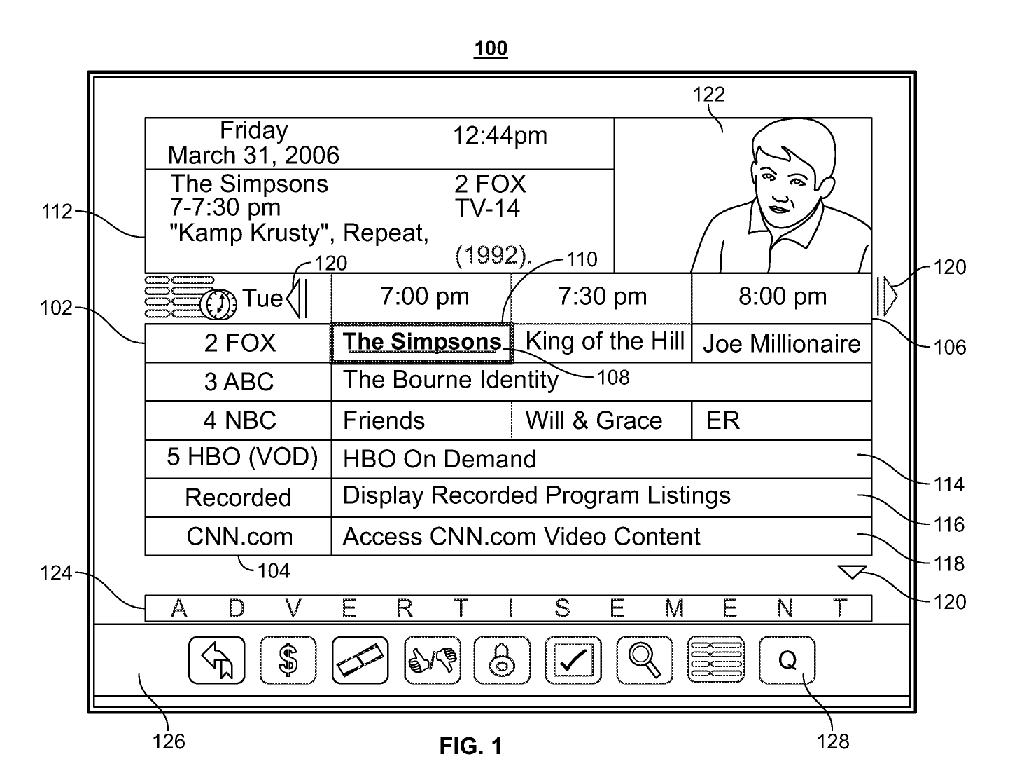

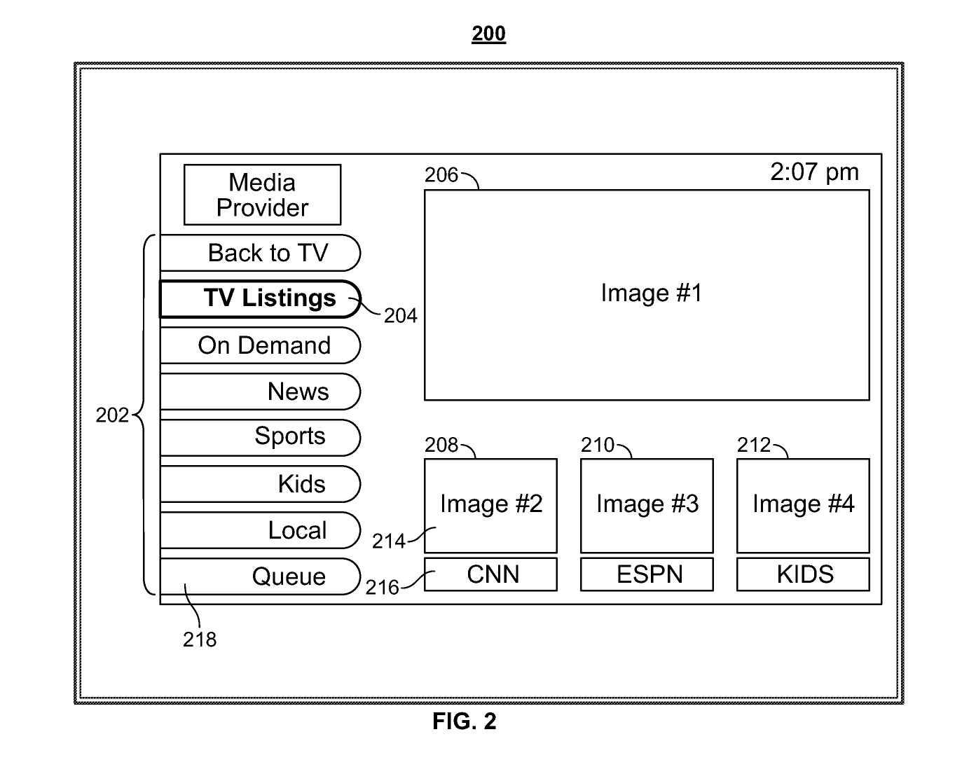

FIGS. 1-2 show illustrative display screens that may be used to provide media guidance data. The display screens shown in FIGS. 1-2, 6A-7, and 9A-C may be implemented on any suitable user equipment device or platform. While the displays of FIGS. 1-2, 6A-7, and 9A-C are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

In some embodiments, a user may indicate a desire to access a media content queue by selecting a selectable option provided in a display screen (e.g., a menu option, menu tab, or icon) or pressing a dedicated button (e.g., a QUEUE button) on a remote control or other user input interface or device. As referred to herein, the term “media content queue” or “queue” should be understood to mean any list of content or content identifiers that identifies which content to download to the local storage of a mobile device. A media content queue may be a playlist, assets, or portions of assets. In some embodiments, in response to a user input indicating a desire to access a media content queue, control circuitry on a user equipment device may provide a media content queue display screen that includes media content identified to be of interest to the user. In some embodiments, the media content queue may be provided by the media guidance application. In some embodiments, the user input indicating a desire to access a media content queue may be received by control circuitry on a first user equipment device, and in response to receiving the user input, a media content queue display screen may be provided for display by control circuitry on a second user equipment device that acts as a second screen device. Using a second user equipment device, such as a mobile device, as a second screen device may allow the user to view a media guidance application display screen on the first user equipment device while viewing a media content queue on the second screen device. As referred to herein, the term “mobile device” should be understood to mean any portable user equipment device, such as a laptop computer, a tablet computer, a hand-held computer, a personal digital assistant (PDA), a mobile telephone, a portable video player, a portable music player (e.g., iPod, MP3 player), a portable gaming machine, and a smart phone.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. For example, advertisement 124 may correspond to or be associated with media content in a media content queue associated with a user. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, media content in a media content queue, a scheduled event on a calendar, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database coupled to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

In some embodiments, options region 126 may include a selectable option 128 to display a media content queue that includes media content identified to be of interest to a user. If a user selects selectable option 128 to display a media content queue, control circuitry on a user equipment device may provide a media content queue display screen that includes media content identified to be of interest to the user. In some embodiments, the selection of a selectable option to display a media content queue may be received by control circuitry on a first user equipment device, and in response to receiving the selection, a media content queue display screen may be provided for display by control circuitry on a second user equipment device that acts as a second screen device. Using a second user equipment device, such as a mobile device, as a second screen device may allow the user to view program listings display 100 on the first user equipment device while viewing a media content queue on the second screen device, or view program listings display 100 on the second screen device while viewing a media content queue on the first user equipment device.

In some embodiments, options region 126 may include a selectable option to display a calendar associated with the user. If a user selects the selectable option to display a calendar, control circuitry on a user equipment device may provide a calendar display screen that includes various scheduled events for the user. In some embodiments, the selection of a selectable option to display a calendar may be received by control circuitry on a first user equipment device, and in response to receiving the selection, a calendar display screen may be provided for display by control circuitry on a second user equipment device that acts as a second screen device. Using a second user equipment device, such as a mobile device, as a second screen device may allow the user to view program listings display 100 on the first user equipment device while viewing a calendar on the second screen device, or view program listings display 100 on the second screen device while viewing a calendar on the first user equipment device.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

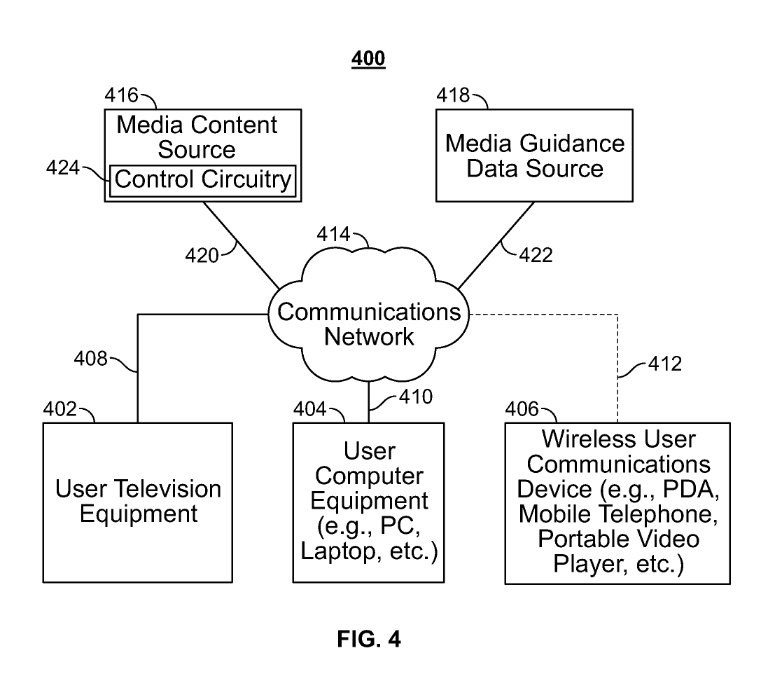

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com or www.facebook.com, from other media guidance applications the user accesses, from other interactive applications the user accesses, from other content sources like iTunes and Netflix the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

In some embodiments, control circuitry of a mobile device may use GPS circuitry or other position information circuitry to monitor a user's location at various times during each day over a period of several days. The location information may be stored in a user profile. The control circuitry may also generate probabilities of where the user will be at a certain time during the day based on the stored location information. The generated probabilities may also be stored in the user profile. In some embodiments, control circuitry of a mobile device may monitor patterns of user behavior at various locations and/or whether the user uses the mobile device at various times during the day. The information about patterns of user behavior and mobile device usage may be stored in the user profile. A media guidance application, content source, or user equipment device may access this stored user profile information to personalize the user's experience with the media guidance application, content source, or user equipment device.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

In some embodiments, selectable options 202 may include a selectable option 218 to display a media content queue that includes media content identified to be of interest to a user. If a user selects selectable option 218 to display a media content queue, control circuitry on a user equipment device may provide a media content queue display screen that includes media content identified to be of interest to the user. In some embodiments, the selection of a selectable option to display a media content queue may be received by control circuitry on a first user equipment device, and in response to receiving the selection, a media content queue display screen may be provided for display by control circuitry on a second user equipment device that acts as a second screen device. Using a second user equipment device, such as a mobile device, as a second screen device may allow the user to view video mosaic display 200 on the first user equipment device while viewing a media content queue on the second screen device, or view video mosaic display 200 on the second screen device while viewing a media content queue on the first user equipment device.

In some embodiments, selectable options 202 may include a selectable option to display a calendar associated with the user. If a user selects the selectable option to display a calendar, control circuitry on a user equipment device may provide a calendar display screen that includes various scheduled events for the user. In some embodiments, the selection of a selectable option to display a calendar may be received by control circuitry on a first user equipment device, and in response to receiving the selection, a calendar display screen may be provided for display by control circuitry on a second user equipment device that acts as a second screen device. Using a second user equipment device, such as a mobile device, as a second screen device may allow the user to view video mosaic display 200 on the first user equipment device while viewing a calendar on the second screen device, or view video mosaic display 200 on the second screen device while viewing a calendar on the first user equipment device.

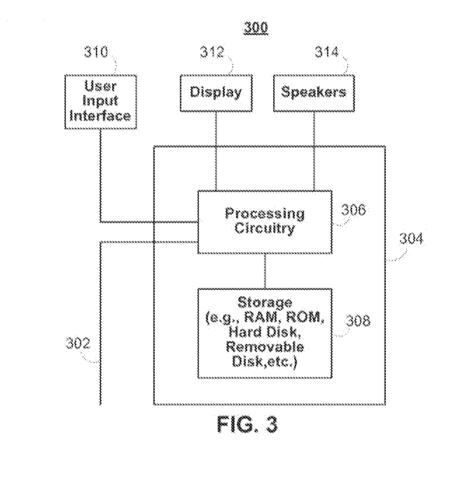

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. In some embodiments, user equipment device 300 may receive media content from a content resource, such as the Internet, an iTunes server, a Netflix server, or another user equipment device. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. I/O path 302 may also provide information about content accessed by other users using other user equipment devices coupled to a network. Control circuitry 304 may monitor media content that a user requests and consumes on user equipment device 300. In some embodiments, control circuitry 304 may monitor media content that a user requests or consumes from a second screen device coupled to user equipment device 300 via I/O path 302. Control circuitry 304 may be used to send and receive commands, requests, and other suitable data using I/O path 302. I/O path 302 may couple control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may include position information circuitry, such as Global Positioning System (GPS) circuitry, location-based services (LPS) circuitry, triangulation circuitry, hybrid positioning systems circuitry, or any other suitable position obtaining circuits or combinations of such circuits. Control circuitry 304 may use the position information obtained from the position information circuitry to determine the current position of user equipment device 300. In some implementations, control circuitry 304 may obtain the current position of user equipment device 300 by accessing a social network, such as over the Internet. For example, control circuitry 304 may monitor a status update posted to the social network for the user. Control circuitry 304 may parse the status update for information that identifies a current location of the user (e.g., name of a venue or event the user is attending). In some implementations, control circuitry 304 may monitor a status update of a friend of the user on the social network. In particular, control circuitry 304 may parse the status update of the friend of the user for information that identifies a particular location or event and the name of the user. In some implementations, control circuitry 304 may obtain the current position of user equipment device 300 by accessing a calendar associated with the user.

Control circuitry 304 may identify media content of interest to a user. In some embodiments, control circuitry 304 may identify media content that is similar to media content the user has previously requested or consumed on user equipment device 300 or another user equipment device. In some embodiments, control circuitry 304 may receive recommendations of media content from a friend or family member of the user or by a content source, such as Netflix or iTunes, via I/O path 302. Control circuitry 304 may identify media content that is popular among the user's friends or among general users of a network. In some embodiments, control circuitry 304 may access a calendar associated with the user and identify a person or location associated with a scheduled event on the calendar. Control circuitry 304 may also identify media content relevant to an identified person or location.

In some embodiments, control circuitry 304 detects whether user equipment device 300 has access to a network. In some embodiments, control circuitry 304 determines when user equipment device 300 will have limited access to a network. As referred to herein, the phrase “limited access” to a network should be understood to mean degraded network conditions, slow network connection, not having network access at all (i.e., lacking access to a network), any network or device condition which prevents or makes unsuitable the transfer of content from one device to another, or any combination of the same. Control circuitry 304 may determine when user equipment device 300 will have limited access to a network by analyzing scheduled events on a calendar or by monitoring patterns of use of user equipment device 300. In some embodiments, control circuitry 304 determines an optimal time to receive media content from a content source or to transmit media content to another user equipment device, such as a mobile device.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be an entertainment cache used to store various types of content described herein as well as media guidance information, described above, and guidance application data, described above. In some embodiments, storage 308 may be used to store a media content queue or a calendar associated with a user. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. For example, a user may use user input interface 310 to instruct control circuitry 304 to display a media content queue or access a calendar associated with the user. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to couple multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. For example, a first device may be used to display a user's calendar while a second screen device identifies and displays media content related to one or more scheduled events on the calendar. In some embodiments, the second screen device provides an interface for adjusting settings and display preferences of the first device. In some embodiments, the second screen device is configured for interacting with other second screen devices or for interacting with a social network. In some embodiments, the second screen device may be a mobile device. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space couplings (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety. In some embodiments, content source 416 may include control circuitry 424. Control circuitry 424 may be implemented in content source 416 in a similar manner as control circuitry 304 is implemented in user equipment device 300 of FIG. 3.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and a server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. An OTT content provider may provide recommendations of media content similar to media content that a user has previously accessed, requested, purchased, or viewed from the OTT content provider. An OTT content provider may also collect information about commonly accessed, requested, purchased, or viewed media content among users of the OTT content provider. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices coupled via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video, streamed video, media content queue, or calendar. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on coupled devices. These cloud-based services may allow a user equipment device to store content to the cloud and to receive content from the cloud rather than storing content locally and accessing locally-stored content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

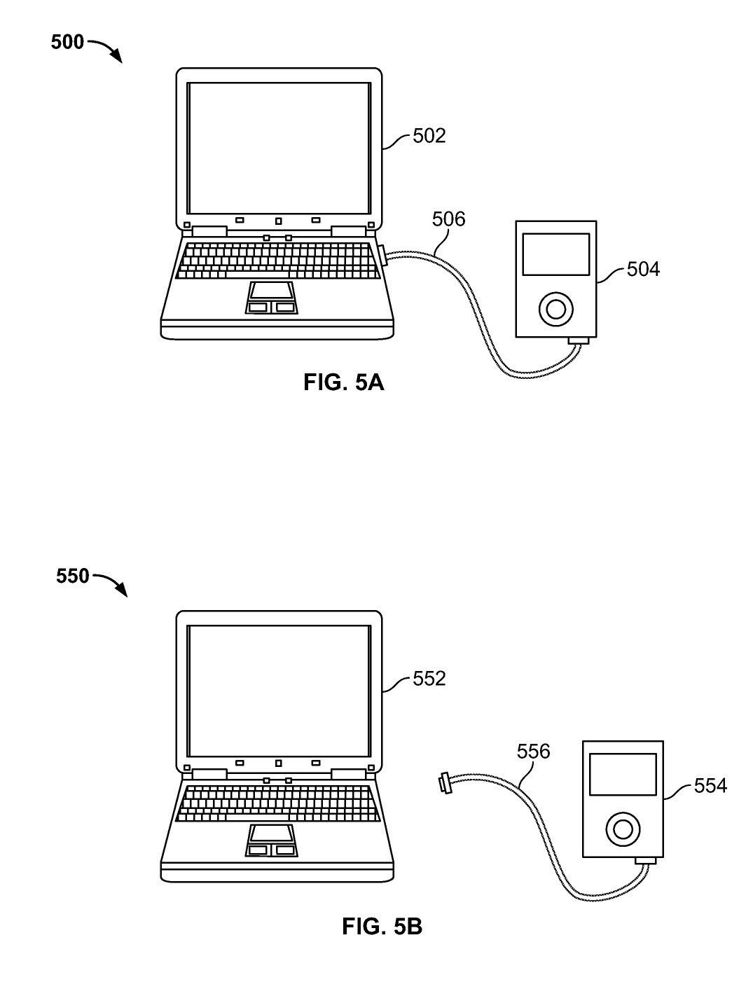

FIG. 5A shows an illustrative system 500 where a mobile device 504 can access media content from a content source 502. In some embodiments, content source 502 may be a website content provider or an OTT content provider, such as iTunes, Netflix, or Hulu. In some embodiments, content source 502 may be a user equipment device, such as a television, desktop PC, or laptop. Mobile device 504 may be an iPod, PDA, cellular phone, portable video player, or other portable device. In some embodiments, content source 502 and mobile device 504 are physically coupled with a cable 506. Cable 506 may be a USB cable, IEEE 1394 cable, Ethernet cable, connection to a docking station, or other short-range wired communication path. In some embodiments, content source 502 and mobile device 504 may be wirelessly coupled (e.g., via Bluetooth, IEEE 802-11x, 3G, 4G, or Wi-Fi).

While content source 502 and mobile device 504 are coupled to each other, mobile device 504 may be able to access media content that is available on a network. In some embodiments, mobile device 504 can access media content from an online or OTT content source directly, such as via a 3G or Wi-Fi network. For example, mobile device 504 may access music on iTunes, video content on Netflix, or photos on Flickr. In some embodiments, mobile device 504 by itself may not be able to access the Internet, but may be able to access media content from an online content source (or through an OTT content source over cable/satellite) through another user equipment device. For example, the other user equipment device may access an online content source using a web browser or an application running on the user equipment device and download desired media content, which may then be transferred to mobile device 504 via cable 506 or a wireless path. In some embodiments, content source 502 may be a user equipment device that is a cloud resource. For example, the user equipment device may have an electronic memory on which media content such as photos and videos are stored. Media content stored on the user equipment device may be transmitted to mobile device 504 via cable 506 or a wireless path and stored in an electronic memory on mobile device 504.

In some embodiments, mobile device 504 may function as a second screen device. For example, a user may watch an episode of a show on a television and use mobile device 504 to watch a recap or read a summary of what happened in previous episodes of the show. In some embodiments, the television and mobile device 504 may be coupled to the same communications network and control circuitry on mobile device 504 may identify which show the user is watching on the television. The control circuitry on mobile device 504 may then automatically search for a recap or summary of what happened in previous episodes of the show.

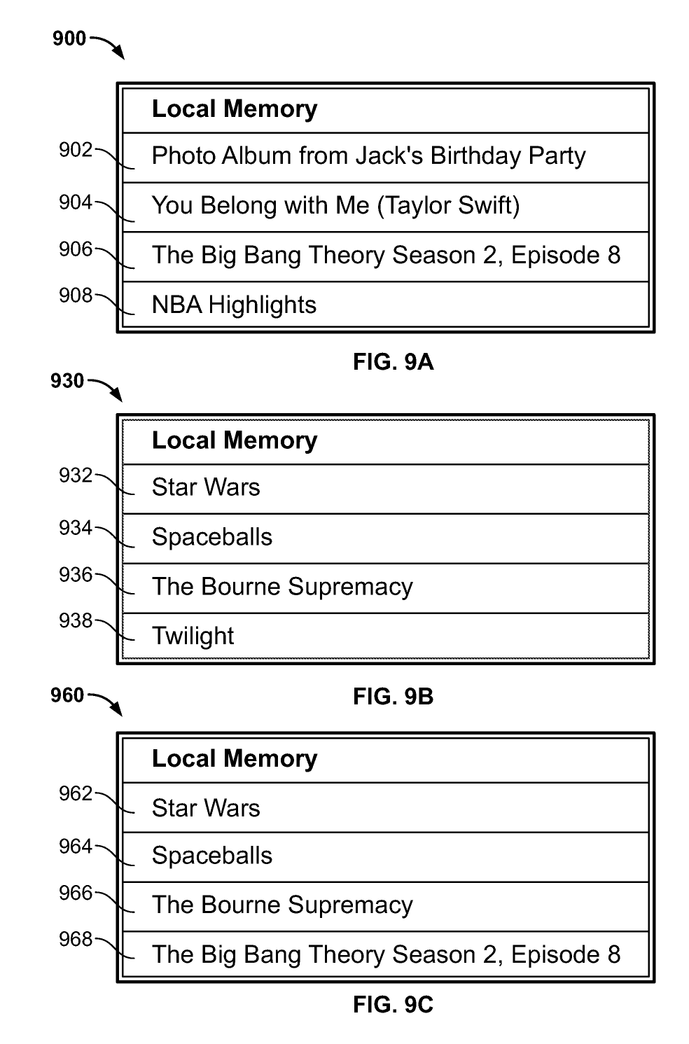

At times, a mobile device may lack access to a network and be unable to access a content source. FIG. 5B shows a system 550 in which mobile device 554 has been decoupled from content source 552. Content source 552 in FIG. 5B corresponds to content source 502 in FIG. 5A, mobile device 554 in FIG. 5B corresponds to mobile device 504 in FIG. 5A, and cable 556 in FIG. 5B corresponds to cable 506 in FIG. 5A. If cable 556 is decoupled from content source 552, as shown in FIG. 5B, mobile device 554 may lose its network connection to content source 552. Similarly, if a wireless coupling between content source 552 and mobile device 554 is broken, mobile device 554 may no longer have access to media content on content source 552. For example, if a user of mobile device 554 is driving and enters an underground tunnel, mobile device 554 may not be able to access a 3G or Wi-Fi network in the tunnel and will not have access to media content on content source 552. In some embodiments, if mobile device 554 cannot access online content without being coupled to another user equipment device, mobile device 554 will not be able to access media content on content source 552 when mobile device 554 is decoupled from the other user equipment device. When mobile device 554 lacks access to a network, mobile device 554 no longer has access to all of the media content available over the network and only has access to the media content that is stored locally in the memory of mobile device 554. Media content locally stored in memory is further discussed with respect to FIGS. 9A-C.

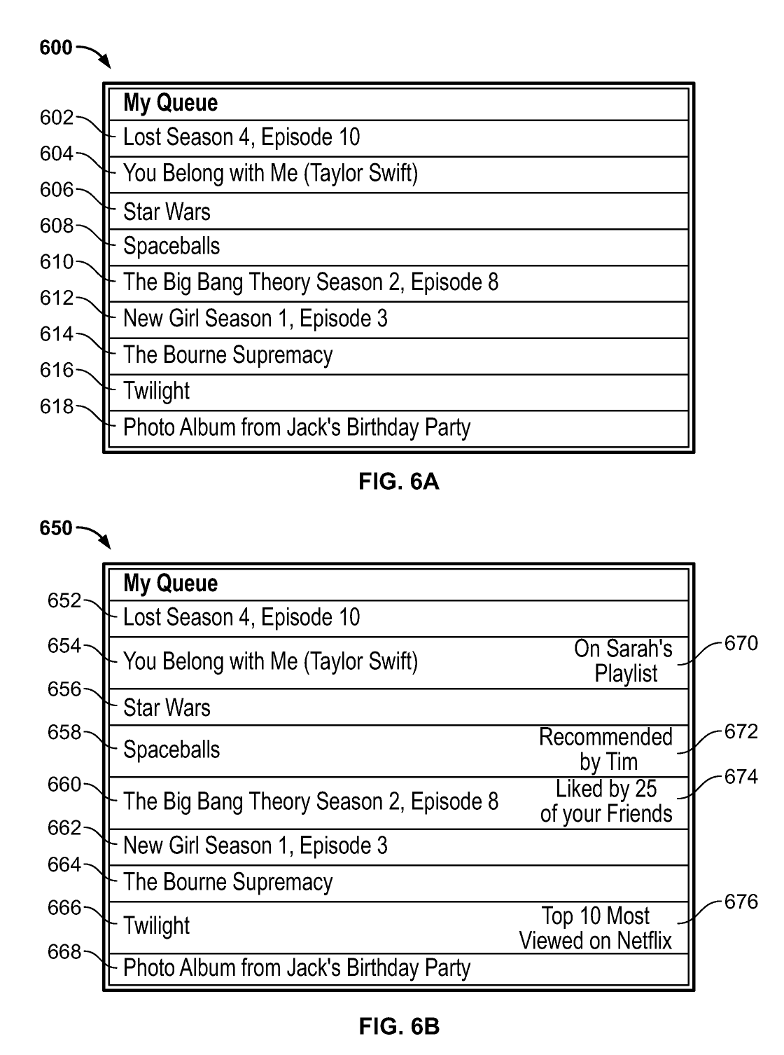

In some embodiments, media content of interest to a user may be added to a media content queue. FIG. 6A shows an illustrative display screen 600 of a media content queue in accordance with an embodiment of the invention. In some embodiments, the queue may be stored on a remote server that is coupled to the network. In some embodiments, the queue may be stored on a user equipment device that operates in a cloud computing environment.

The exemplary media content queue in FIG. 6A includes media content of several different types, although in some embodiments the queue may include fewer types of media content. Media content 602, 610, and 612 are episodes of television shows. Media content 604 is a song. Media content 606, 608, 614, and 616 are movies. Media content 618 is an electronic photo album. In some embodiments, the media content in the queue may be available from a plurality of signal sources. For example, media content 604 may be available from an Internet source, media content 606 and 608 may be available from a cable source, and media content 614 may be available from a satellite source.

In some embodiments, media content that matches stored user preferences may be added to the queue. The stored user preferences may be stored locally in memory 308 of a user equipment device, on a remote server coupled to a network, or on a cloud resource. Media content that matches stored user preferences may be identified and added to a queue by control circuitry 304 of a mobile device, such as mobile device 504, or by control circuitry of a content source (e.g. control circuitry on a Netflix or iTunes server).

In some embodiments, a media guidance application may identify media content of interest to a user based on the user's viewing history. The user's viewing history may include media content that the user has accessed on multiple user equipment devices, not just a mobile device. Media content based on the user's viewing history may include media content that the user has previously viewed and expressed interest in, media content similar to media content that the user has previously viewed, and media content that references media content that the user has previously viewed. For example, if the user has previously watched the movie “Star Wars,” a media guidance application may add the movie “Spaceballs,” which parodies “Star Wars,” to the queue, or instruct control circuitry 304 to do so. In some embodiments, media content based on the user's viewing history may include an episode of a series of which the user has watched other episodes. For example, media content 612, the media guidance application may add, or instruct control circuitry 304 to add, an episode of the television series “New Girl” to the queue because the user watched the pilot episode of “New Girl.”

In some embodiments, a content source, such as content source 502, may identify media content as being of interest to a user. Control circuitry of a content source may keep track of media content that a user has previously accessed, requested, purchased, or viewed using the content source. The control circuitry of the content source may identify media content similar to the previously accessed, requested, purchased, or viewed media content as being of interest to the user. In some embodiments, the control circuitry of the content source may add the identified media to a media content queue associated with the user.

In some embodiments, control circuitry of a mobile device, such as mobile device 504, may keep track of media content that a user has previously accessed, requested, purchased, or viewed from various content sources. The control circuitry of the mobile device may track user activity on the mobile device as well as on other devices. The control circuitry of the mobile device may identify media content similar to the previously accessed, requested, purchased, or viewed media content as being of interest to the user. In some embodiments, the control circuitry of the mobile device may add the identified media to a media content queue associated with the user.

In some embodiments, a content resource like iTunes or Netflix may recommend media content to a user based on media content that the user has previously purchased or based on media content that is popular among other users of the content resource. In some embodiments, control circuitry 304 of a mobile device may receive a recommendation of media content for the user from a friend of the user. The recommended media content may be added to the queue by control circuitry of the content resource or control circuitry 304 of a mobile device.

In some embodiments, a media content queue display may include indicators of why some of the media content was added to the queue. FIG. 6B shows an illustrative display screen 650 of a media content queue with indicators in accordance with an embodiment of the invention. Media content queue display 650 includes media content 652, 654, 656, 658, 660, 662, 664, 666, and 668, which correspond, respectively, to media content 602, 604, 606, 608, 610, 612, 614, 616, and 618 in display 600 of FIG. 6A.

In some embodiments, media content may be added to the queue because friends of the user have expressed interest in the media content. For example, control circuitry 304 of a mobile device may add media content 654, which is a song, to the queue after control circuitry 304 of the mobile device identifies the same song as being on an iTunes playlist created by Sarah, a friend of the user's. Media content queue display 650 may include an indicator 670 stating that the song is on Sarah's playlist. In some embodiments, another friend of the user's, Tim, may have recommended that the user watch media content 658, which is a movie. Media content queue display 650 may include an indicator 672 stating that Tim has recommended the movie to the user. Indicators displayed with the queue may be generated by control circuitry 304 of the mobile device or control circuitry of a content source.

In some embodiments, the media queue may include content that has not been specifically recommended to the user but is popular among several of the user's friends or among general users of a content resource. For example, indicator 674 may inform the user that 25 of the user's friends on Facebook have “liked” Season 2, Episode 8 of the television show “The Big Bang Theory,” which appears as media content 660 in the user's queue. Indicator 676 may inform the user that the movie Twilight, which appears as media content 666 in the user's queue, is among the top ten most viewed items on Netflix.

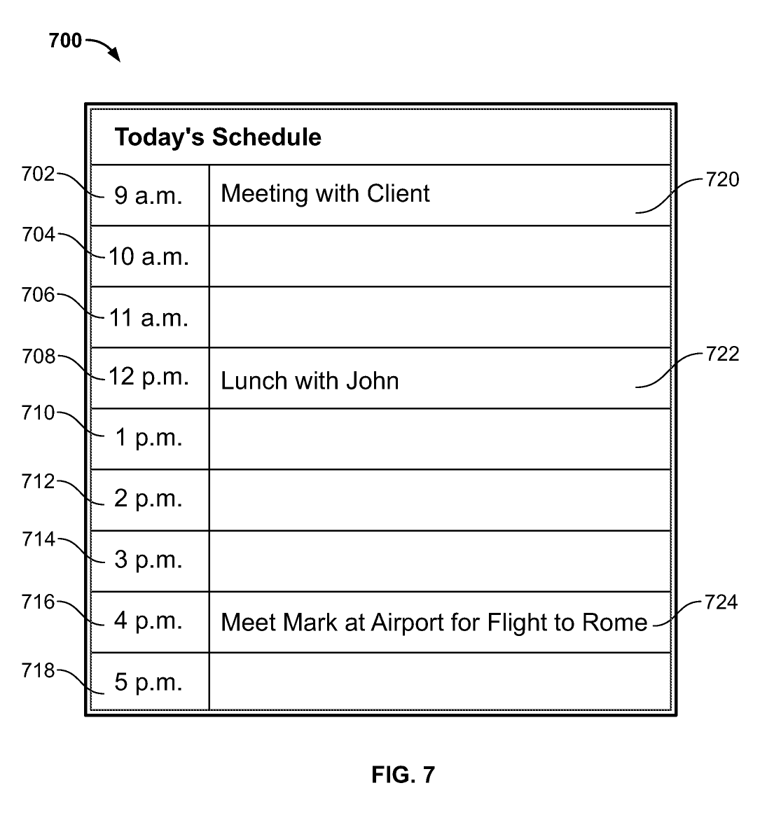

In some embodiments, some of the media content in the queue may be pushed to a user equipment device while the user equipment device is coupled to a network. In particular, a content source may retrieve content corresponding to selected content in the queue and transmit the content to the mobile device for storage in a local memory of the mobile device without the mobile device requesting the content. In some embodiments, control circuitry 304 of mobile device 504 may download media content in the queue into memory 308 of mobile device 504 while mobile device 504 has access to content source 502. In some embodiments, media content may be downloaded onto a user equipment device, such as a mobile device, in a different order than the media content was added to the queue. In some embodiments, an optimal time to automatically download media content onto a user's mobile device may be determined based on a calendar associated with the user, as discussed further with respect to FIG. 7.

FIG. 7 shows an illustrative display screen 700 of a calendar in accordance with an embodiment of the invention. Calendar display screen 700 includes time slots 702, 704, 706, 708, 710, 712, 714, 716, and 718 and several scheduled events 720, 722, and 724. Scheduled event 720 indicates a meeting that the user has with a business client. Scheduled event 722 indicates that the user is supposed to meet a friend, John, for lunch. Scheduled event 724 indicates that the user is supposed to meet another friend, Mark, at the airport to catch a flight to Rome.

In some embodiments, a calendar associated with a user, such as the calendar shown on display screen 700, is accessible over a network by multiple user equipment devices. In some embodiments, the calendar may be locally stored on a mobile device. Control circuitry 304 on the mobile device may access the calendar to determine an optimal time to automatically transmit media content in a queue to the mobile device. Control circuitry 304 may determine a possible location of a scheduled event on the calendar and cross-reference the possible location with a network availability data structure in order to determine an optimal time to automatically transmit content.

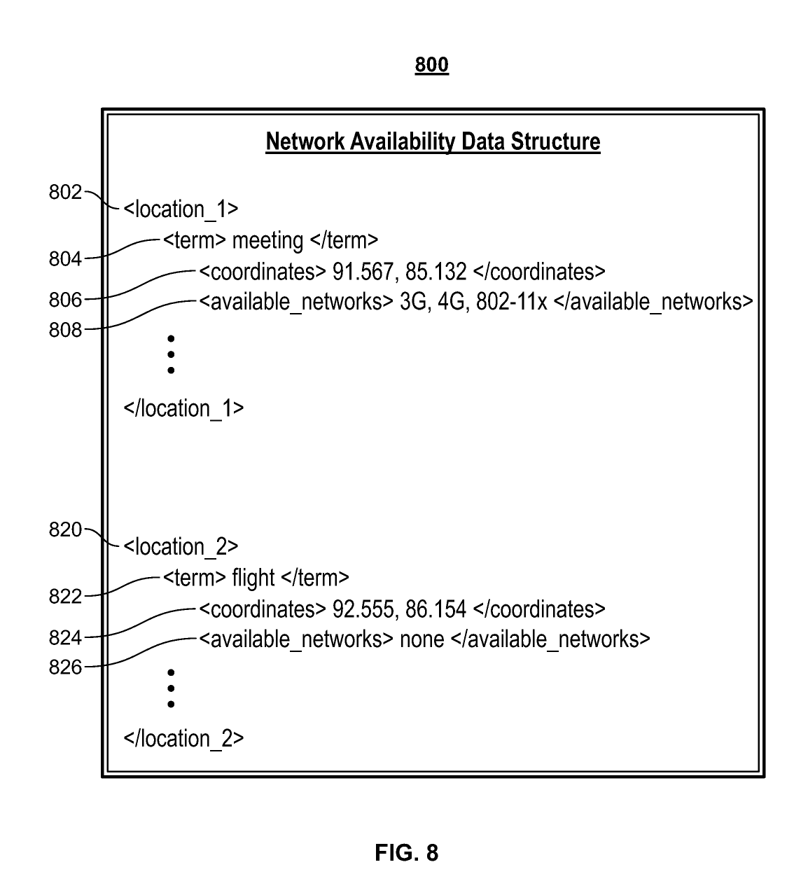

FIG. 8 shows an illustrative network availability data structure 800 that may be used to determine whether a network is available at a location in accordance with an embodiment of the invention. Control circuitry 304 may retrieve network availability data structure 800 from a database stored in a local memory of the mobile device or from a database stored on an external source (e.g., a website on the Internet, a memory of a cloud resource). Control circuitry 304 may compare terms in a scheduled event on the calendar to term fields 804 and 822 corresponding to respective location fields 802 and 820. If a term in a scheduled event matches or is substantially similar to at least one of term fields 804 and 822, control circuitry 304 may communicate to the database the term, and the database may return to control circuitry 304 the information in the corresponding location field(s) (802 and/or 820) and available network field(s) (808 and/or 826). In some embodiments, available network fields 808 and 826, or other fields in network availability data structure 800, may include network speed information for any available network(s). In some embodiments, if a location corresponding to a term in a scheduled event has at least one available network, and if control circuitry 304 determines that the user is unlikely to use the mobile device while at that location (e.g., by accessing a stored user profile that includes information about patterns of user behavior at various locations), control circuitry 304 may determine that the duration of the scheduled event is an optimal time to automatically transmit content to the mobile device. It should be understood that any of the steps for determining an optimal time to automatically transmit content may be performed by control circuitry of a content source (e.g., control circuitry 424 of media content source 416).

For example, control circuitry 304 may access the calendar of FIG. 7 and retrieve from a database network availability data structure 800 and determine that the term “meeting” in scheduled event 720 matches term field 804. Control circuitry 304 may communicate the term “meeting” to the database (e.g., via I/O path 302), and the database may return to control circuitry 304 the location “office building” and available networks 3G, 4G, and 802-11x. Control circuitry 304 may access, on a cloud resource, a stored user profile for the user and determine that the user usually does not use the mobile device during meetings. Since the user's meeting, scheduled to take place from 9-10 a.m., will occur in an office building where the mobile device will have access to at least one network, and since the user will likely not be using the mobile device during the meeting, control circuitry 304 may determine that 9-10 a.m. is an optimal time to push media content from the queue to the mobile device. From 9-10 a.m., control circuitry may automatically download media content into memory 308 of the mobile device from an appropriate content source.

Downloading media content onto the mobile device during the meeting time may be better than downloading media content during the other scheduled events because the user is likely to use the mobile device during the other scheduled events, or the mobile device will have limited access to a network during the other scheduled events in FIG. 7. For example, during the scheduled lunch, the user may want to use the mobile device to show John pictures or videos. While the user is on a flight, the mobile device will not be able to access any networks, which control circuitry 304 could determine by receiving the information of fields 822 and 826 from the database on which network availability data structure 800 is stored. Even if the mobile device could access a network during the flight, the user will likely be watching movies or playing games on the mobile device during the flight to pass the time, and the speed of the network that is available during the flight will be slower than the speed of the available network(s) at the user's office building. Control circuitry 304 may also determine that downloading media content during the meeting time may be better than downloading content during time slots without scheduled events because the user could choose to use the mobile device at any time during the unscheduled time slots, which may interrupt or slow down the download. In addition, the network speed at the office building may be faster, and the network connection more reliable, than at other locations where the user will be later in the day.

In some embodiments, control circuitry may retrieve network availability data structure 800 to determine whether the mobile device currently has access to a network. For example, control circuitry 304 may retrieve a network availability data structure 800 (FIG. 8) from a local memory 308 of the mobile device. Control circuitry 304 may use GPS circuitry to obtain the current GPS coordinates of the mobile device. Control circuitry 304 may then analyze coordinates fields 806 and 824 and their corresponding available networks fields 808 and 826. In particular, control circuitry 304 may search through coordinates fields 806 and 824 for GPS coordinates that are within a predetermined range (e.g., half a mile) of the current GPS coordinates obtained from the GPS circuitry of the mobile device. If the coordinates of a coordinates field are within the predetermined range of the current GPS coordinates of the mobile device and the corresponding available networks field lists available networks, control circuitry 304 may determine that the mobile device currently has access to a network.

In some embodiments, control circuitry 304 of the mobile device may access the calendar to determine a possible location of the user at a future time and download media content relevant to the possible location onto the mobile device. A scheduled event on the calendar may indicate a location where the user will be during a certain time period. Scheduled event 722 may, for example, identify the restaurant where the user is meeting John for lunch. In some embodiments, scheduled event 722 may not identify where the user is meeting John, but control circuitry 304 on the mobile device may identify possible locations for the lunch based on information about the user and John. For example, control circuitry 304 on the mobile device may access the Facebook profiles of the user and John and determine that the user and John both like Mexican food. Control circuitry 304 may determine where the user and John work and identify a nearby Mexican restaurant as a possible location for the lunch. Control circuitry 304 may then download the restaurant's menu or coupons for the restaurant onto the user's mobile device. In some embodiments, control circuitry 304 may determine that the user is meeting John for lunch at John's home. Control circuitry 304 may download driving directions from the user's workplace to John's house onto the user's mobile device.

In some embodiments, control circuitry 304 on a mobile device may cross-reference a scheduled event on a calendar with a network availability data structure to identify a future time when a mobile device will lack access to a network. Control circuitry 304 may communicate with a database on which a network availability data structure is stored to identify a location of a scheduled event on the calendar and determine that the mobile device will not be able to access a network at the location. In some embodiments, control circuitry 304 may determine whether network access will be available at the location by looking up information on a website or recognizing patterns of usage during similar scheduled events or at similar locations in the past (e.g., by accessing a stored user profile). When control circuitry 304 identifies a location for a scheduled event and determines that no network access will be available at the location, control circuitry 304 may determine that the start time of the scheduled event is a future time when the mobile device will lack access to a network. In some embodiments, control circuitry 304 may determine the current time and calculate the difference between the current time and the start time of the scheduled event.

Control circuitry 304 may then identify media content to download to local memory 308 of the mobile device during the time period between the current time and the start time of the scheduled event. Content may be selected based on the duration of the scheduled event or based on a person or location associated with the scheduled event. Control circuitry may determine the network speed (e.g., by pinging a network server) and the file size of the selected content (e.g., by communicating with a content source from which the content is available) and determine how much time is needed to download a particular content by dividing the file size of the particular content by the network speed. Control circuitry 304 may then select, for downloading to local memory 308 of the mobile device, media content for which there is adequate time to complete the download.

In some embodiments, control circuitry 304 may calculate the remaining time needed to download media content that is being downloaded to local memory 308 at the current time. Such a calculation may be performed by dividing the file size of the content that has not yet been downloaded by the network speed. If this calculated time is greater than the difference between the current time when media content is being downloaded and the start time of a scheduled event associated with a location where the mobile device will not have network access, control circuitry 304 may devote more resources of the mobile device to downloading media content in order to complete the downloading process before the start time of the scheduled event. In some embodiments, if the difference between the current time when the mobile device has access to a network and the start time of a scheduled event associated with a location where the mobile device will not have network access is below a threshold time, control circuitry 304 may devote more resources of the mobile device to downloading media content in order to speed up the downloading process. The threshold time may be set by the user or by control circuitry of the mobile device or content source. It should be understood that any calculations or determinations relevant to identifying a future time when a mobile device will lack access to a network or selecting media content to download may be performed by control circuitry of a content source from which media content is available.

For example, if scheduled event 724 includes the departure time of the user's flight, control circuitry 304 may determine (e.g., by looking up Federal Aviation Administration regulations on an Internet website or by receiving available networks information from a database on which a network availability data structure is stored) that the mobile device will not have access to a network around the departure time since all electronic devices must be turned off when an airplane takes off. In some embodiments, control circuitry 304 may identify media content in the media content queue that is relevant to the user's destination or that would be suitable for viewing on a plane. Control circuitry 304 may calculate the difference between the current time and the departure time to determine how much time remains before the mobile device will lose network access. Control circuitry 304 may also determine the network speed and the file size of various media content in the queue and calculate how long it will take to download the identified media content. Control circuitry 304 may then select for downloading media content for which there is adequate time to complete the download. In some embodiments, if a current time when media content is being downloaded is close to the departure time (e.g., within 10 minutes of the departure time), control circuitry 304 may devote more resources of the mobile device to the downloading process to speed it up.

In some embodiments, control circuitry 304 on a mobile device may identify patterns of user behavior. In particular, control circuitry 304 may retrieve a user profile that indicates where the user is at various times during the day or what times during the day the user tends to use or not use the mobile device. Control circuitry 304 may retrieve the user profile from local memory 308 of the mobile device or from a cloud resource. For example, control circuitry 304 may determine that the user usually does not use the mobile device from 8-8:30 a.m. on weekdays because that is when the user usually drives to work and the user does not use the mobile device while driving. If control circuitry 304 detects a 3G network between 8 and 8:30 a.m. on a weekday, control circuitry 304 may download media content into memory 308 of the mobile device. In some embodiments, the mobile device may have GPS capabilities. While the user is driving to work, control circuitry 304 of the mobile device may use the GPS capabilities to determine the user's current location, direction, and speed. Control circuitry 304 may determine that at the speed the user is driving along the current route, the user will enter an underground tunnel in 5 minutes, during which the mobile device will not have access to any network. Control circuitry 304 may select for download media content that can be completely downloaded in less than 5 minutes, or may devote more resources to the current download process after determining that at the current speed the download will not be complete in the next 5 minutes.

When a mobile device lacks access to a network, the mobile device only has access to content stored locally in the memory of the mobile device. In some embodiments, the local memory of a mobile device may be a media content cache. In some embodiments, the media content stored in the cache may be the highest possible quality version of the media content. Because a local memory of a mobile device likely cannot store all media content of interest to a user, some of the media content must be selected for local storage.

FIG. 9A shows an illustrative display screen 900 of media content stored in a local memory of a mobile device in accordance with an embodiment of the invention. The media content stored in the local memory of the mobile device may include media content selected by a content source from a media content queue to be pushed into the local memory. Control circuitry on the mobile device may identify the media content stored in local memory and generate display screen 900. The local memory of FIG. 9A includes media content 902, 904, 906, and 908. Media content 902, 904, 906, and 908 may correspond to media content 618, 604, and 610, respectively, in the media content queue of FIG. 6A. Media content 908 may be media content that was already stored in the local memory of the mobile device before media content 902, 904, and 906 were transmitted to the mobile device.

In some embodiments, media content may be selected for transmission to local memory of a mobile device based on an environment of the mobile device at a future time. The environment may include a person associated with the user. For example, control circuitry of a content source or control circuitry of the mobile device may access a calendar associated with the user and determine from a scheduled event, such as scheduled event 722 of FIG. 7, that the user will meet with a friend at a designated time. Before the designated time, control circuitry of a content source or control circuitry of the mobile device may automatically select, from a media content queue, media content associated with the friend for transmission to the user's mobile device while the mobile device is coupled to a network. Since scheduled event 722 indicates that the user will meet with John, control circuitry of a content source or control circuitry of the mobile device may select media content that the user will likely want to show John for download into the local memory of the user's mobile device. For example, media content 902, an electronic photo album from an event called “Jack's birthday party,” may be selected because control circuitry has determined (e.g., by accessing the user's calendar and John's calendar) that both the user and John attended the party, and the user and John will likely want to view photos from the party together. Media content 904, a song, may be selected because the song is of a genre that John likes and the user may want to share the song with John.

In some embodiments, a future environment on which to base selection of media content for transmission to local memory may include a geographical location. For example, control circuitry of a content source or control circuitry of the mobile device may access the calendar of FIG. 7 and determine from scheduled event 724 that the user is going to Rome, Italy. The control circuitry of a content source or control circuitry of the mobile device may automatically select, from a media content queue, media content that is relevant to Rome, Italy, for transmission to the user's mobile device while the mobile device is coupled to a network. The selected media content may include news articles about events in Rome, video clips about tourist attractions in Rome, and movies that take place in Rome.

In some embodiments, control circuitry of a content source or control circuitry of a mobile device may also select media content for transmission to local memory of the mobile device based on how long a scheduled event will last. For example, if the user's lunch meeting with John is only scheduled to last for an hour, an episode of short show they both like, such as The Big Bang Theory (whose episodes are only about 25 minutes long without commercials), may be selected instead of an episode of a longer show, such as Lost (which has hour-long episodes), that both the user and John like.

In some embodiments, control circuitry of a content source or control circuitry of a mobile device may select media content for transmission to the mobile device based on the nature and duration of an event. For example, if a user will be on a long flight in the near future, several movies may be downloaded onto the mobile device rather than shorter media content so that the user can be entertained during the entire flight. FIG. 9B shows an illustrative display screen 930 of media content stored in a local memory of a mobile device in anticipation of a long flight. The media content stored in the local memory of the mobile device may include media content selected by a content source from a media content queue to be pushed into the local memory. Control circuitry on the mobile device may identify the media content stored in local memory and generate display screen 930. Display screen 930 includes media content 932, 934, 936, and 938, all movies, which correspond to media content 606, 608, 614, and 616 of FIG. 6A.

In some embodiments, time or device constraints may affect which media content is selected for transmission to the mobile device. For example, after several movies for a user to watch on a flight have been downloaded onto a mobile device, control circuitry of a content source or control circuitry of the mobile device may determine that while there is enough space for another movie in memory 308 of the mobile device, there is not enough time (e.g., because of slow network speed) to download another movie in its entirety. Instead of part of a movie being downloaded, media content with a shorter duration, such as an episode of a television show, may be downloaded instead so that all media content can be transmitted in its entirety. In some embodiments, a television show instead of a movie may be selected for download into local memory of the mobile device because control circuitry of a content source or control circuitry of the mobile device has determined that there is enough memory space for a television show but not for a movie.

FIG. 9C shows an illustrative display screen 960 of media content stored in a local memory in accordance with an embodiment of the invention involving time or device constraints. The media content stored in the local memory of the mobile device may include media content selected by a content source from a media content queue to be pushed into the local memory. Control circuitry on the mobile device may identify the media content stored in local memory and generate display screen 960. The local memory of FIG. 9C includes media content 962, 964, 966, and 968. Media content 962, 964, and 966 in FIG. 9C correspond to media content 932, 934, and 936, respectively, in FIG. 9B. Media content 968 of FIG. 9C may be of shorter duration than media content 938 of FIG. 9B and may have been selected instead of media content 938 because control circuitry of a content source or control circuitry of the mobile device determined that there was not enough time or enough memory space to download media content 938.

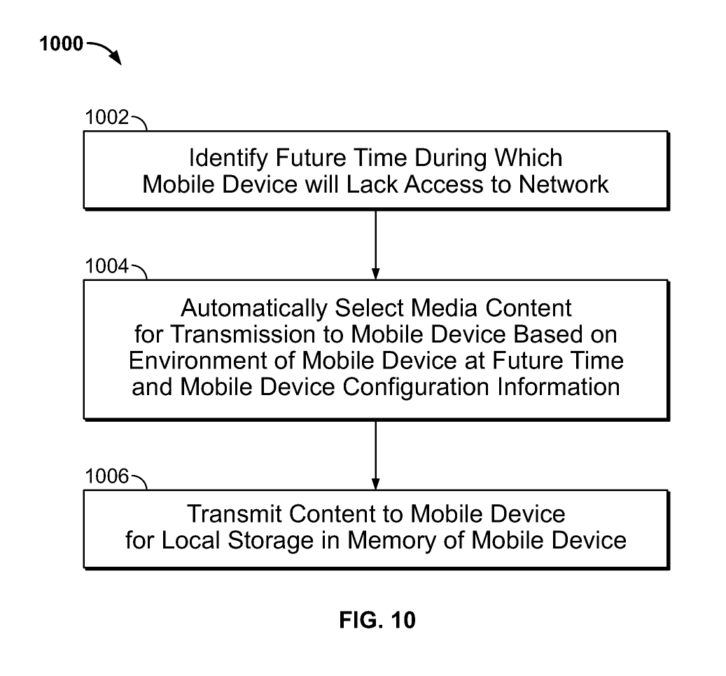

FIG. 10 is an illustrative flow diagram 1000 for managing media content in accordance with an embodiment of the invention. At step 1002, a future time is identified during which a mobile device will lack access to a network. In some embodiments, a future time may be identified during which a mobile device will have limited access to a network. Control circuitry of a content source or control circuitry of the mobile device may identify the future time by accessing a calendar associated with the user. In some embodiments, scheduled events on the calendar may indicate when the mobile device will have limited access to the network.

In some embodiments, control circuitry 304 on a mobile device may cross-reference a scheduled event on a calendar with a network availability data structure (e.g., network availability data structure 800) to identify a future time when a mobile device will lack access to a network. Control circuitry 304 may communicate with a database on which a network availability data structure is stored to identify a location of a scheduled event on the calendar and determine that the mobile device will not be able to access a network at the location. In some embodiments, control circuitry 304 may determine whether network access will be available at the location by looking up information on a website or recognizing patterns of usage during similar scheduled events or at similar locations in the past (e.g., by accessing a stored user profile). When control circuitry 304 identifies a location for a scheduled event and determines that no network access will be available at the location, control circuitry 304 may determine that the start time of the scheduled event is a future time when the mobile device will lack access to a network. In some embodiments, control circuitry 304 may determine the current time and calculate the difference between the current time and the start time of the scheduled event. It should be understood that any calculations or determinations relevant to identifying a future time when a mobile device will lack access to a network may be performed by control circuitry of a content source. It should also be understood that similar calculations and/or determinations may be performed, by control circuitry of the mobile device or of a content source, for situations where mobile device access to a network will be limited.

At step 1004, media content is automatically selected for transmission to the mobile device based on an environment of the mobile device at a future time. The environment may include a geographical location, another person a user of the mobile device may meet with, a length of time the mobile device will be at a geographical location, or a length of time the mobile device will lack access to the network. Control circuitry of a content source or control circuitry of the mobile device may identify a possible environment and suitable media content for the environment by accessing a calendar associated with the user. In some embodiments, media content may also be automatically selected for transmission to the mobile device based on mobile device configuration information. The mobile device configuration information may include the size of memory of the mobile device, processor type of the mobile device, and communications circuitry of the mobile device.

In some embodiments, control circuitry 304 may determine the network speed (e.g., by pinging a network server) and the file size of the selected content (e.g., by communicating with a content source from which the content is available) and determine how much time is needed to download a particular content by dividing the file size of the particular content by the network speed. Control circuitry 304 may then select, for downloading to local memory 308 of the mobile device, media content for which there is adequate time to complete the download. It should be understood that any calculations or determinations relevant to selecting content for downloading to the mobile device may be performed by control circuitry of a content source.

In some embodiments, media content may be selected for transmission to local memory of a mobile device based on a person associated with the user. For example, control circuitry of a content source or control circuitry of the mobile device may access a calendar associated with the user and determine from a scheduled event, such as scheduled event 722 of FIG. 7, that the user will meet with a friend at a designated time. Before the designated time, control circuitry of a content source or control circuitry of the mobile device may automatically select, from a media content queue, media content associated with the friend for transmission to the user's mobile device while the mobile device is coupled to a network. Control circuitry of a content source or control circuitry of the mobile device may select for download media content that the user will likely want to share with the friend, such as an electronic photo album from an event that both the user and the friend attended, or media content of a genre that the friend likes.

In some embodiments, control circuitry of a content source or control circuitry of the mobile device may access a calendar and select media content for download to the mobile device based on a geographical location indicated by a scheduled event of the calendar. The control circuitry of a content source or control circuitry of the mobile device may automatically select, from a media content queue, media content that is relevant to the geographical location, such as news articles, video clips about tourist attractions, and movies that take place at the geographical location.

In some embodiments, control circuitry of a content source or control circuitry of a mobile device may select media content for transmission to the mobile device based on the nature and duration of a scheduled event. For example, if a user will be on a long flight in the near future, several movies may be downloaded onto the mobile device rather than shorter media content so that the user can be entertained during the entire flight.

In some embodiments, time or device constraints may affect which media content is selected for transmission to the mobile device. For example, after several movies for a user to watch on a flight have been downloaded onto a mobile device, control circuitry of a content source or control circuitry of the mobile device may determine that while there is enough space for another movie in memory 308 of the mobile device, there is not enough time (e.g., because of slow network speed) to download another movie in its entirety. Instead of part of a movie being downloaded, media content with a shorter duration, such as an episode of a television show, may be downloaded instead so that all media content can be transmitted in its entirety. In some embodiments, a television show instead of a movie may be selected for download into local memory of the mobile device because control circuitry of a content source or control circuitry of the mobile device has determined that there is enough memory space for a television show but not for a movie.

At step 1006, the content is transmitted to the mobile device for storage in a memory of the mobile device. In some embodiments, the memory may be a local memory of the mobile device. In some embodiments, a content source may retrieve content corresponding to selected content in the queue and transmit the content to the mobile device for storage in a local memory of the mobile device without the mobile device requesting the content. In some embodiments, media content may be downloaded onto a user equipment device, such as a mobile device, in a different order than the media content was added to the queue.

In some embodiments, control circuitry of the mobile device identifies an optimal time for transmitting media content to the mobile device by accessing a calendar, such as the calendar discussed above with respect to FIG. 7. In some embodiments, control circuitry 304 may determine a possible location of a scheduled event on the calendar and cross-reference the possible location with a network availability data structure (e.g., network availability data structure 800) in order to determine an optimal time to automatically transmit content. Control circuitry 304 may retrieve a network availability data structure from a database stored in a local memory of the mobile device or from a database stored on an external source (e.g., a website on the Internet, a memory of a cloud resource). Control circuitry 304 may compare terms in a scheduled event on the calendar to term fields corresponding to respective location fields. If a term in a scheduled event matches or is substantially similar to at least one of term fields, control circuitry 304 may communicate to the database the term, and the database may return to control circuitry 304 the information in the corresponding location field(s) and available network field(s). In some embodiments, if a location corresponding to a term in a scheduled event has at least one available network, and if control circuitry 304 determines that the user is unlikely to use the mobile device while at that location (e.g., by accessing a stored user profile that includes information about patterns of user behavior at various locations), control circuitry 304 may determine that the duration of the scheduled event is an optimal time to automatically transmit content to the mobile device. It should be understood that any of the steps for determining an optimal time to automatically transmit content may be performed by control circuitry of a content source (e.g., control circuitry 424 of media content source 416).

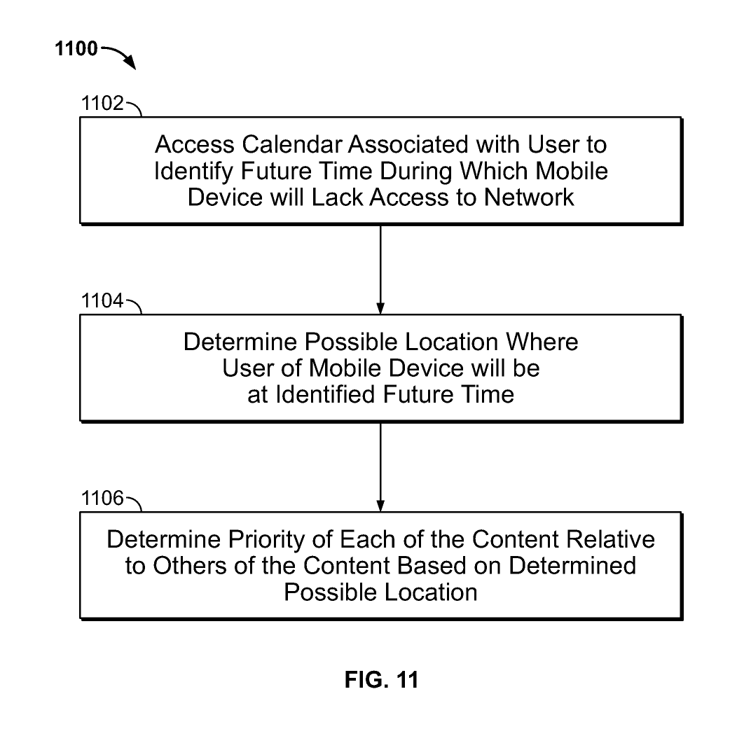

FIG. 11 is an illustrative flow diagram 1100 for prioritizing media content in accordance with an embodiment of the invention. At step 1102, a calendar associated with a user of a mobile device is accessed to identify a future time during which the mobile device will lack access to a network. In some embodiments, control circuitry 304 on a mobile device may cross-reference a scheduled event on the calendar with a network availability data structure (e.g., network availability data structure 800) to identify a future time when a mobile device will lack access to a network. Control circuitry 304 may compare terms in a scheduled event on the calendar to term fields in the network availability data structure. If a term in a scheduled event matches or is substantially similar to one of term fields, control circuitry 304 may communicate the term to the database on which the network availability data structure is stored, and the database may return to control circuitry 304 the information in the corresponding available networks field. If the returned available networks field information is “none,” control circuitry 304 may determine that the time period of the scheduled event is a future time during which the mobile device will lack access to a network. It should be understood that any calculations or determinations relevant to identifying a future time during which a mobile device will lack access to a network may be performed by control circuitry of a content source. It should also be understood that similar calculations and/or determinations may be performed, by control circuitry of the mobile device or of a content source, for situations where mobile device access to a network will be limited.

At step 1104, a possible location is determined where the user of the mobile device will be at the identified future time. In some embodiments, control circuitry of a content source or control circuitry of the mobile device may retrieve a user profile to access probabilities of where the user will be at the identified future time. The probabilities may be calculated based on location information collected by GPS circuitry or other position information circuitry on the mobile device. In some embodiments, control circuitry of a content source or control circuitry of the mobile device may determine a possible location based on scheduled events on the calendar. In some embodiments, a scheduled event may explicitly identify a location of an event. In some embodiments, control circuitry of a content source or control circuitry of the mobile device may infer a location based on other information about the scheduled event or the user. Possible locations may include a restaurant, a home of a friend, an office building, or an airport.

In some embodiments, control circuitry 304 on a mobile device may cross-reference a scheduled event on the calendar with a network availability data structure (e.g., network availability data structure 800) to determine a possible location where the user of the mobile device will be at the identified future time. Control circuitry 304 may compare terms in a scheduled event on the calendar to term fields in the network availability data structure. If a term in a scheduled event matches or is substantially similar to one of term fields, control circuitry 304 may communicate the term to the database on which the network availability data structure is stored, and the database may return to control circuitry 304 the information in the corresponding location field. It should be understood that any steps relevant to determining a possible location where the user of the mobile device will be at the identified future time may be performed by control circuitry of a content source.

At step 1106, a priority of each of the content is determined relative to others of the content based on the determined possible location. In some embodiments, control circuitry of a content source or control circuitry of the mobile device may give higher priority to content that has a setting at the determined possible location than to content that does not have a setting at the location. For example, if the determined possible location is a geographical location, higher priority may be given to news articles about the geographical location, video clips about tourist attractions at the geographical location, and movies that take place at the geographical location than to similar content that takes place at a different geographical location.

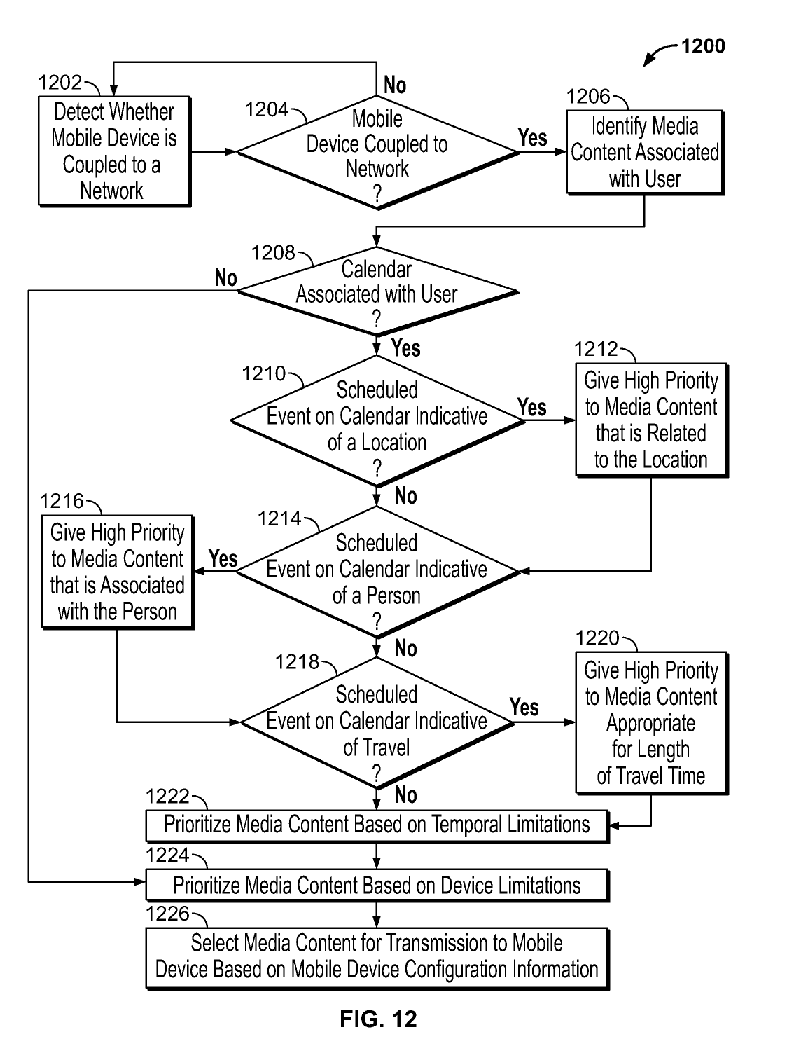

In some embodiments, control circuitry of a content source or control circuitry of the mobile device may prioritize content based on another person who will be at the determined possible location. For example, control circuitry of a content source or control circuitry of the mobile device may determine that the possible location is a friend's home, and may identify, from a media content queue, media content that the user will likely want to access while at the friend's home. Such identified media content may be given higher priority for download to a memory of the mobile device than other media content in the media content queue. Prioritizing media content is further discussed below with respect to FIG. 12.

FIG. 12 is an illustrative flow diagram 1200 for selecting media content for transmission to a mobile device in accordance with an embodiment of the invention. At step 1202, control circuitry detects whether a mobile device is coupled to a network. In some embodiments, control circuitry 304 of a mobile device may detect a physical coupling between the mobile device and a content source, as illustrated in FIG. 5A. In some embodiments, control circuitry 304 of a mobile device may detect availability of a 3G or Wi-Fi network.

At step 1204, control circuitry, for example control circuitry 304 of a mobile device, determines whether the mobile device is coupled to a network. If the mobile device is not coupled to a network, the process returns to step 1202. If the mobile device is coupled to a network, the process proceeds to step 1206.

At step 1206, media content associated with the user is identified. In some embodiments, control circuitry of a content source or control circuitry of the mobile device identifies media content that matches user preferences. In some embodiments, control circuitry of a content source may identify media content based on media content the user has previously accessed, requested, purchased, or viewed from the content source. In some embodiments, control circuitry of a mobile device may identify media content based on a user's viewing history. The user's viewing history may include media content that has been accessed, requested, purchased, or viewed on a plurality of user equipment devices from a plurality of content sources.

At step 1208, it is determined whether a calendar associated with the user is available. The determination at step 1208 may be made by control circuitry of a content source or control circuitry of the mobile device. If no calendar is available, the process proceeds to step 1224. If a calendar is available, the process proceeds to step 1210.

At step 1210, it is determined whether a scheduled event on the calendar is indicative of a location. The determination at step 1210 may be made by control circuitry of a content source or control circuitry of the mobile device. If a scheduled event on the calendar is not indicative of a location, the process proceeds directly to step 1214. If a scheduled event is indicative of a location, the process proceeds to step 1212. At step 1212, high priority is given to media content that is related to the location. For example, if a scheduled event is indicative of a geographical location, maps of the location informational videos about the location, and promotions associated with the location may be given high priority. From step 1212, the process proceeds to step 1214.

At step 1214, it is determined whether a scheduled event on the calendar is indicative of a person. The determination at step 1214 may be made by control circuitry of a content source or control circuitry of the mobile device. If a scheduled event on the calendar is not indicative of a person, the process proceeds directly to step 1218. If a scheduled event is indicative of a person, the process proceeds to step 1216. At step 1216, high priority is given to media content that is associated with the person. For example, if a scheduled event indicates that the user is meeting with a friend, media content that is recommended by or of interest to the friend will have a higher priority than media content that is popular among users of the network in general, such as viral videos on the Internet. From step 1216, the process proceeds to step 1218.

At step 1218, it is determined whether a scheduled event on the calendar indicates that the user will be traveling. The determination at step 1218 may be made by control circuitry of a content source or control circuitry of the mobile device. If a scheduled event on the calendar is not indicative of travel, the process proceeds directly to step 1222. If a scheduled event is indicative of travel (e.g., mentions going to the airport or identifies a departure time), the process proceeds to step 1220. At step 1220, high priority is given to media content that is appropriate for the length of travel time. For example, if a user will be flying overseas, higher priority may be given to movies than to short videos. Control circuitry of a content source or control circuitry of the mobile device may identify whether media content is appropriate for the length of travel time. From step 1120, the process proceeds to step 1222.

At step 1222, the media content is prioritized based on temporal limitations. For example, control circuitry of a content source or control circuitry of the mobile device may prioritize media content based on how long the mobile device will have access to a network before an identified future time when the mobile device will have limited access to the network, the length of time the mobile device will lack access to the network, the length of time the mobile device will be at a location, or the network speed. In some embodiments, if a mobile device will lose access to the network in the near future, control circuitry of a content source or control circuitry of the mobile device may assign higher priority to media content that can be downloaded in the time before network access is lost than media content that cannot be completely downloaded in the short period of time. From step 1222, the process proceeds to step 1224.

At step 1224, the media content is prioritized based on device limitations. Device limitations may be determined by control circuitry of a content source or control circuitry of the mobile device, and may include memory available on the mobile device and playback capabilities of the mobile device. For example, media content that will fit in the available memory on the mobile device may have higher priority than media content whose size exceeds that of the free memory on the mobile device. Media content that the mobile device is capable of playing back may have higher priority than media content that the mobile device is not capable of playing back. For example, control circuitry of a content source or control circuitry of the mobile device may assign higher priority to a television show than to a movie shot in 3D if the mobile device does not have 3D playback capabilities.

In some embodiments, the criteria used to determine the priority of the media content may be weighted. In some embodiments, control circuitry of a content source or control circuitry of the mobile device may weight relevance of media content to a user's friend or family member more heavily than relevance to a location when determining the priority of media content. In some embodiments, temporal limitations may be weighted more heavily than relevance of media content to a friend or family member. In some embodiments, the user may specify the weighting scheme. In some embodiments, the weighting scheme may be automatically determined by a content source or application.

In some embodiments, media content that a user's friend or family member has recommended may be given higher priority than media content that are popular among general users on the network. For example, in the queue of FIG. 6B, media content 658, which is recommended by a friend of the user, may be given higher priority than media content 666, which is generally popular among users of Netflix. In some embodiments, media content associated with a series of which the user has watched many episodes may be given higher priority than other media content based on the user's viewing history. For example, in the queue of FIG. 6B, media content 652 may be given higher priority than media content 662. In some embodiments, a first media content has a higher priority than a second media content that references the first media content. For example, the movie “Star Wars” may be given a higher priority than the movie “Spaceballs” because a viewer would first have to watch “Star Wars” in order to understand some of the humor in “Spaceballs.”

At step 1226, media content is selected for transmission to the mobile device based on mobile device configuration information. The selection at step 1226 may be performed by control circuitry of a content source or control circuitry of the mobile device. In some embodiments, as many of the highest priority media content as will fit in the memory of the mobile device will be stored. In some embodiments, control circuitry of a content source or control circuitry of the mobile device may consider the processor type and communications circuitry of the mobile device when selecting media content for transmission to the mobile device.

It should be understood that the above steps of the flow diagrams of FIGS. 10-12 may be executed or performed in any order or sequence not limited to the order and sequence shown and described in each figure. Also, some of the above steps of the flow diagrams of FIGS. 10-12 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for managing media content, the method comprising:
identifying a future time during which a mobile device access to a network will be limited;
automatically selecting media content for transmission to the mobile device based on an environment of the mobile device at the future time; and
transmitting the content to the mobile device for storage in a memory of the mobile device.

2. The method of claim 1, further comprising:
determining a possible location where a user of the mobile device will be at the identified future time; and
wherein automatically selecting media content for transmission to the mobile device comprises determining the priority of each of the content relative to others of the content based on the determined possible location.

3. The method of claim 2, further comprising determining the priority of each of the content based on at least one of how long the mobile device will have access to the network before the identified future time, network speed, memory available on the mobile device, and playback capabilities of the mobile device.

4. The method of claim 2, wherein identifying the future time during which the mobile device access to the network will be limited comprises accessing a calendar associated with the user, and wherein the determined possible location is a location indicated by a scheduled event on the calendar.

5. The method of claim 2, wherein the determined possible location is a home of a friend of the user, and wherein the priority of each of the content is determined based on what type of media content the user will likely want to access while at the home of the friend.

6. The method of claim 1, wherein the environment of the mobile device at the future time comprises at least one of an airport, a venue, a geographical location, another user associated with a user of the mobile device, a length of time the mobile device will be at a geographical location, and a length of time the mobile device will lack access to the network.

7. The method of claim 1, further comprising automatically selecting media content for transmission to the mobile device based on mobile device configuration information, wherein the mobile device configuration information comprises at least one of size of memory of the mobile device, processor type of the mobile device, and communications circuitry of the mobile device.

8. The method of claim 1, further comprising automatically selecting media content for transmission to the mobile device based on a measure of time representing when the mobile device will lose access to the network.

9. The method of claim 1, further comprising determining an optimal time to automatically transmit the content to the mobile device.

10. The method of claim 1, wherein the selected content is transmitted without receiving a request from the mobile device.

11. A system for managing media content, the system comprising processing circuitry configured to:
identify a future time during which a mobile device access to a network will be limited;
automatically select media content for transmission to the mobile device based on an environment of the mobile device at the future time; and
transmit the content to the mobile device for storage in a memory of the mobile device.

12. The system of claim 11, wherein the processing circuitry is further configured to:
determine a possible location where a user of the mobile device will be at the identified future time; and
determine the priority of each of the content relative to others of the content based on the determined possible location.

13. The system of claim 12, wherein the processing circuitry is further configured to determine the priority of each of the content based on at least one of how long the mobile device will have access to the network before the identified future time, network speed, memory available on the mobile device, and playback capabilities of the mobile device.

14. The system of claim 12, wherein the processing circuitry is further configured to access a calendar associated with the user to identify the future time during which the mobile device access to the network will be limited, and wherein the determined possible location is a location indicated by a scheduled event on the calendar.

15. The system of claim 12, wherein the determined possible location is a home of a friend of the user, and wherein the priority of each of the content is determined based on what type of media content the user will likely want to access while at the home of the friend.

16. The system of claim 11, wherein the environment of the mobile device at the future time comprises at least one of an airport, a venue, a geographical location, another user associated with a user of the mobile device, a length of time the mobile device will be at a geographical location, and a length of time the mobile device will lack access to the network.

17. The system of claim 11, wherein the processing circuitry is further configured to automatically select media content for transmission to the mobile device based on mobile device configuration information, and wherein the mobile device configuration information comprises at least one of size of memory of the mobile device, processor type of the mobile device, and communications circuitry of the mobile device.

18. The system of claim 11, wherein the processing circuitry is further configured to automatically select media content for transmission to the mobile device based on a measure of time representing when the mobile device will lose access to the network.

19. The system of claim 11, wherein the processing circuitry is further configured to determine an optimal time to automatically transmit the selected content to the mobile device.

20. The system of claim 11, wherein the selected content is transmitted without receiving a request from the mobile device.

21-30. (canceled)
